(19) United States
(12) Patent Application Publication
(10) Pub. No.: US 2024/0373252 A1
(43) Pub. Date: Nov. 7, 2024

(54) METHOD AND APPARATUS FOR MANAGING INTERFERENCE IN A WIRELESS COMMUNICATION SYSTEM

(71) Applicant: Samsung Electronics Co., Ltd., Suwon-si (KR)

(72) Inventors: Bharath S, Bangalore (IN); Jeonghyeon JANG, Suwon-si (KR); Ashok Kumar Reddy CHAVVA, Bangalore (IN)

(21) Appl. No.: 18/654,588

(22) Filed: May 3, 2024

(30) Foreign Application Priority Data
May 5, 2023 (IN) 202341032188
Apr. 16, 2024 (IN) 2023 41032188

(51) Int. Cl. H04W 24/02; H04B 17/309; H04L 5/00

(52) U.S. Cl. CPC H04W 24/02; H04B 17/346; H04L 5/0051

(57) ABSTRACT

The disclosure relates to a 5th generation (5G) or 6th generation (6G) communication system for supporting a higher data transmission rate. A method and a Base Station (BS) for determining an optimal equalizer for managing interference in a communication network are provided. The method includes estimating channel coefficients of each slot of a plurality of slots based on received Demodulation Reference Signal (DM-RS) symbols, determining a covariance of interference-and-noise (R_{z}) matrix for at least one Resource Block (RB) of a plurality of RBs of each slot based on the channel coefficients, determining a noise variance (σ²) based on noise measurements performed for one or more sub-carriers without the interference, and determining an optimal equalizer from a plurality of equalizers for managing the interference, based on diagonal elements of the R_{z} matrix and σ² of the at least one RB using a machine learning model.

### CROSS-REFERENCE TO RELATED APPLICATION(S)

This application is based on and claims priority under 35 U.S.C. § 119(a) of an Indian Provisional patent application number 202341032188, filed on May 5, 2023, in the Indian Patent Office, and of an Indian Complete patent application number 202341032188, filed on Apr. 16, 2024, in the Indian Patent Office, the disclosure of each of which is incorporated by reference herein in its entirety.

### BACKGROUND

### 1. Field

The disclosure relates to wireless networks. More particularly, the disclosure relates to a method, an apparatus and system for determining an optimal equalizer for managing interference in a wireless communication system.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time, a network technology for utilizing satellites, High-Altitude Platform Stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of Artificial Intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive eXtended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Fifth generation (5G) and beyond systems are required to support much heavier uplink traffic due to an increased use of data intensive applications such as social networking and point-to-point video sharing. Achieving higher spectral efficiency is therefore an important requirement in these systems. One of the key factors that limit uplink performance is presence of co-channel interference i.e., interference arising from multiple users/nodes using same frequency resources. In homogeneous networks, co-channel interference arises from neighboring cell users, that can significantly affect the achievable rate for primary cell users. In heterogeneous networks, due to the co-channel deployment of the macro base station (BS) and a large number of low power BSs, the interference is even higher. Therefore, an effective mechanism to alleviate interference at the BS is necessary.

One of the key approaches to mitigate interference in a physical (PHY) layer is via an effective equalization technique. Several uplink detection/equalization algorithms have been proposed over the last two decades for massive MIMO systems, but linear receivers still remain a preferred choice in practical systems due to their simplicity and tractability. In fact, zero-forcing (ZF) and minimum mean squared error (MMSE) equalizers are known to produce near-optimal performance under some regimes, however their performance degrade in the presence of interference.

MMSE with interference rejection combining (MMSE-IRC) has been widely adopted for suppressing the inter-cell and intra-cell interference in spatial domain, and thus achieve higher cell-edge/average spectral efficiency. Although successful in alleviating interference, the MMSE-IRC receiver suffers from a much higher complexity compared with traditional MMSE receiver. Specifically, the complexity of MMSE-IRC is cubic in number of BS antennas, whereas the complexity of MMSE is cubic in number of users. This is particularly concerning given the large number of BS antennas used in 5G and beyond systems, wherein managing the complexity of MMSE-IRC receiver within tolerable limits is one of the serious issues that industry is working on. Currently though there have been some existing systems working in this direction, these methods either require non-trivial changes in existing receiver structure or suffer from significant performance loss in realistic channels due to approximations, both of which are undesirable.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for determining an optimal equalizer for managing interference in a communication network.

Additional aspects will be set forth in part in the description which follows and, in part, will be apparent from the description, or may be learned by practice of the presented embodiments.

In accordance with an aspect of the disclosure, a method performed by a base station (BS) of determining an optimal equalizer for managing interference in a wireless communication system is provided. The method includes estimating, by the BS, channel coefficients of each slot of a plurality of slots based on received Demodulation Reference Signal (DM-RS) symbols, determining a covariance of interference-and-noise (Rz) matrix for at least one Resource Block (RB) of a plurality of RBs of each slot based on the channel coefficients, determining a noise variance (σ2) based on noise measurements performed for one or more sub-carriers without the interference, and determining an optimal equalizer from a plurality of equalizers for managing the interference, based on diagonal elements of the Rz matrix and σ2 of the at least one RB using a machine learning model (an artificial intelligence model).

In accordance with another aspect of the disclosure, a method performed by a base station (BS) of determining an optimal equalizer for managing interference in a communication network is provided. The method includes estimating, by the BS, channel coefficients of each slot of a plurality of slots with respect to time based on received demodulation reference signal (DM-RS) symbols, determining, by the BS, a covariance of interference-and-noise (Rz) matrix for at least one resource block (RB) of a plurality of RBs of each slot based on the channel coefficients, determining, by the BS, a noise variance (σ2) based on noise measurements performed on one or more sub-carriers without the interference, estimating, by the BS, an interference proportion for the at least one RB based on the covariance of interference-and-noise (Rz) matrix and the noise variance (σ2), and determining, by the BS, an optimal equalizer from a plurality of equalizers based on a comparison of the interference proportion with a predetermined interference threshold for the at least one RB.

In accordance with another aspect of the disclosure, a Base Station (BS) for determining an optimal equalizer for managing interference in a communication network is provided. The BS includes memory storing one or more computer programs and one or more processors communicatively coupled to the memory. The one or more computer programs include computer-executable instructions that, when executed by the one or more processors, cause the one or more processors to estimate channel coefficients of each slot of a plurality of slots based on received Demodulation Reference Signal (DM-RS) symbols, determine a covariance of interference-and-noise (Rz) matrix for at least one Resource Block (RB) of a plurality of RBs of each slot based on the channel coefficient, determine a noise variance (σ2) based on noise measurements performed for one or more sub-carriers without the interference, and determine an optimal equalizer from a plurality of equalizers for managing the interference, based on diagonal elements of the Rz matrix and σ2 of the at least one RB using a machine learning model (an artificial intelligence model).

In accordance with another aspect of the disclosure, one or more non-transitory computer-readable storage media storing one or more computer programs including computer-executable instructions that, when executed by one or more processors of a base station (BS), cause the BS to perform operations are provided. The operations include estimating, by the BS, channel coefficients of each slot of a plurality of slots based on received demodulation reference signal (DM-RS) symbols, determining, by the BS, a covariance of interference-and-noise (Rz) matrix for at least one resource block (RB) of a plurality of RBs of each slot based on the channel coefficients, determining, by the BS, a noise variance (σ2) based on noise measurements performed for one or more sub-carriers without the interference, and determining, by the BS, an optimal equalizer from a plurality of equalizers for managing the interference, based on diagonal elements of the Rz matrix and σ2 of the at least one RB using a machine learning model (an artificial intelligence model).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an environment for determining an optimal equalizer for managing interference in a wireless communication system, according to an embodiment of the disclosure;

FIG. 1B illustrates a block of a base station, according to an embodiment of the disclosure;

FIG. 1C illustrates an embodiment of a base station in distributed environment for determining an optimal equalizer for managing interference in a wireless communication system, according to an embodiment of the disclosure;

FIG. 2 illustrates a detailed diagram of a base station for determining an optimal equalizer for managing interference in a wireless communication system, according to an embodiment of the disclosure;

FIGS. 3A and 3B illustrate flow diagrams of determining an optimal equalizer for managing interference in a wireless communication system, according to various embodiments of the disclosure;

FIGS. 4A and 4B illustrate flowcharts illustrating training operations for training a machine learning model for determining an optimal equalizer for managing interference, according to various embodiments of the disclosure;

FIGS. 5A and 5B illustrate graphs representing accuracy of adaptive switching of equalizers according to various embodiments of the disclosure;

FIGS. 6A and 6B illustrate flowcharts illustrating method operations for determining an optimal equalizer for managing interference in a wireless communication system, according to various embodiments of the disclosure;

FIG. 7 illustrates a block diagram of a general-purpose computing system for determining an optimal equalizer for managing interference in a wireless communication system, according to an embodiment of the disclosure;

FIG. 8 illustrates a structure of a base station according to an embodiment of the disclosure; and

FIG. 9 illustrates a structure of a user equipment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Generally, 5G and beyond systems employ a large number of antennas at a Base Station (BS) to achieve high spectral efficiency. Combining signals from large number of antennas significantly increases equalization complexity. These systems are also required to alleviate co-channel interference arising from ever increasing number of wireless devices in a network. Thus, limiting the equalization complexity within tolerable limits, while also effectively alleviating co-channel interference is an important challenge in current systems. Existing systems accept MMSE-IRC as a preferred equalizer in the face of interference and try to approximate/simplify an inverse calculation to reduce the complexity. To do so, existing methods either require non-trivial changes in architecture of receivers or have inferior performance due to inaccurate approximations.

Thus, the disclosure provides a method and a Base Station (BS) for determining an optimal equalizer for managing interference in a communication network. In Multiple-Input and Multiple-Output systems (MIMO), identifying an optimal equalizer plays a crucial role for managing co-channel interferences due to multiple transmissions. The disclosure focuses on adaptive switching between Minimum Mean Squared Error (MMSE) and MMSE-Interference Rejection Combiner (IRC) Receivers for 5G and Beyond systems.

The disclosure realizes that conventional MMSE equalizer achieves either the same or even better performance compared with MMSE-IRC under low-to-moderate interference proportions, while also having much lesser complexity than MMSE-IRC. Based on this observation, the disclosure provides adaptively switching between various equalizers such as, MMSE and MMSE-IRC, based on interference conditions which can reduce equalization complexity of the BS while also improving the performance. The disclosure provides an Artificial Intelligence (AI) based solution to achieve adaptive switching and is shown to reduce equalization complexity for example, up to 66%, while also improving performance compared with MMSE-IRC. Further, the disclosure also discloses determining the optimal equalizer based on a threshold based technique.

Thus, the disclosure provides a solution to an important bottleneck in the 5G and beyond systems. Specifically, the disclosure provides an AI-based methods for significantly reducing the equalization complexity in 5G and beyond BSs, while also improving the equalization performance in the presence of co-channel interference. An embodiment of the disclosure saves significant computational resources and power. The disclosure is also extended to the open radio access network (O-RAN) architecture. An embodiment of the disclosure enables to provide reliable communication to its users even under dense networks with co-channel interference.

Various embodiments disclosed herein relate to 5G and beyond systems, and more particularly to performing adaptive switching between MMSE and MMSE-IRC Receivers in the Uplink for 5G and Beyond.

The fifth generation (5G) and beyond systems are required to support much heavier uplink traffic due to the increased use of data intensive applications such as social networking and point-to-point video sharing. Achieving higher spectral efficiency is therefore an important requirement in these systems. One of the key factors that limit the uplink performance is the presence of co-channel interference. In homogeneous networks with frequency reuse factor one, inter-cell interference can significantly affect the achievable rate. In heterogeneous networks, due to the co-channel deployment of the macro base station (BS) and a large number of low power BSs, the interference is even higher. Therefore, an effective mechanism to alleviate interference at the BS is necessary.

One of the key approaches to mitigate interference in the physical layer is via an effective equalization technique. Several uplink detection/equalization algorithms have been proposed over the last two decades for massive MIMO systems, but linear receivers still remain the preferred choice in practical systems due to their simplicity and tractability. In fact, zero-forcing (ZF) and minimum mean squared error (MMSE) equalizers are known to produce near-optimal performance under some regimes, however their performance degrade in the presence of interference. MMSE with interference rejection combining (MMSE-IRC) has been widely adopted for suppressing the inter-cell and intra-cell interference in the spatial domain, and thus achieve higher cell-edge/average spectral efficiency.

Although successful in alleviating interference, the MMSE-IRC receiver suffers from a much higher complexity compared with traditional MMSE receiver. Specifically, the complexity of MMSE-IRC is cubic in number of BS antennas, whereas the complexity of MMSE is cubic in number of users. This is particularly concerning given the large number of BS antennas used in 5G and beyond systems, wherein managing the complexity of MMSE-IRC receiver within tolerable limits is one of the serious issues that industry is working on. While there have been some prior works in this direction, the proposed methods either require non-trivial changes in the existing receiver structure, or suffer from significant performance loss in realistic channels due to approximations, both of which are undesirable.

The principal object of the embodiments herein is to disclose methods and systems for adaptive switching between MMSE and MMSE-IRC Receivers in the Uplink for 5G and Beyond.

Another object of the embodiments herein is to disclose an opportunistic receiver that switches to MMSE under favorable conditions, such that it achieves both uniformly superior performance as well as reduced average complexity compared with MMSE-IRC.

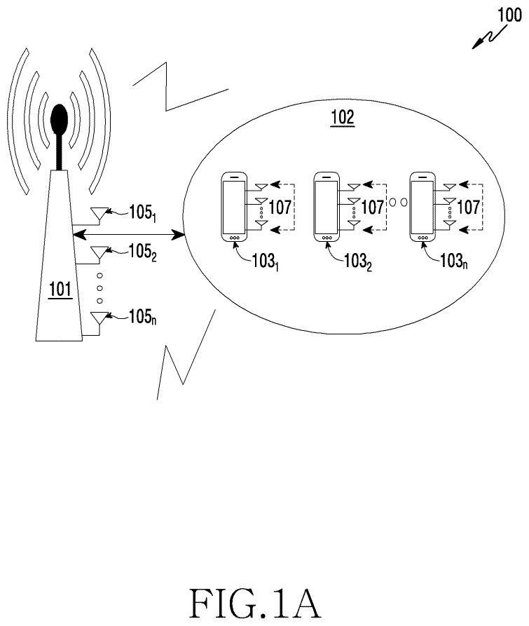

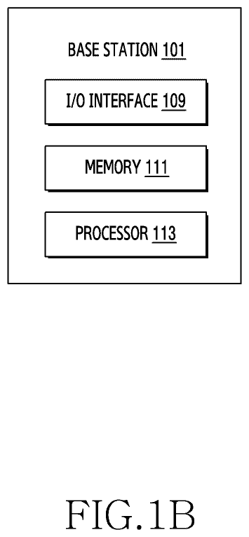

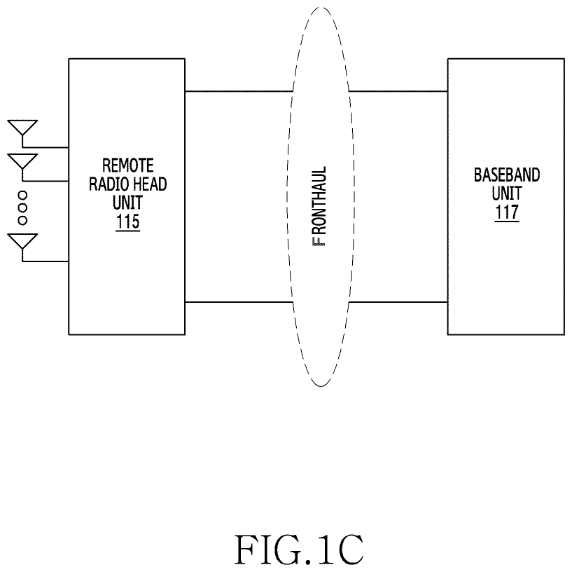

The embodiments herein achieve methods and systems for adaptive switching between MMSE and MMSE-IRC Receivers in the Uplink for 5G and Beyond. Referring now to the drawings, and more particularly to FIGS. 1A to IC, 2, 3A, 3B, 4A, 4B, 5A, and 5B, where similar reference characters denote corresponding features consistently throughout the figures, there are shown at least one embodiment.

Embodiments herein disclose methods and systems for adaptive switching between MMSE and MMSE-IRC Receivers in the Uplink for 5G and Beyond. Embodiments herein disclose an opportunistic receiver that switches to MMSE under favorable conditions, such that it achieves both uniformly superior performance as well as reduced average complexity compared with MMSE-IRC.

### System Model:

Consider an uplink scenario with K single antenna users communicating with M antenna BS. The data transmission takes place in time-units called transmission time interval (TTI), with the basic TTI length being one slot made up of 14 OFDM symbols. The basic time-frequency unit that carries modulation symbols is called a resource element (RE), and a group of 12 consecutive REs in frequency domain form a resource block (RB). Embodiments herein consider the first and the eleventh OFDM symbols of a slot to contain pilot signals, which are referred in NR standards as demodulation reference signals (DMRS).

Let dj(k, l) denote the frequency domain symbol transmit-ted by user j on sub-carrier k of the OFDM symbol l, and hj (k, l) be the corresponding M×1 channel from user j to BS antennas. Let NI denote the number of interferes, with the signal from interferer i denoted by Ii(k, l)∈C^{M×1}. The received signal on sub-carrier k of symbol l at the BS is given by

$$y ( k , ℓ ) = {\sum }_{j = 1}^{K} {h}_{j} ( k , ℓ ) {d}_{j} ( k , ℓ ) + {\sum }_{i - 1}^{{N}_{I}} {I}_{i} ( k , ℓ ) + n ( k , ℓ ) , \qquad ( 1 )$$

where n(k, l) is the M×1 additive white Gaussian noise vector with zero mean and variance σ². Let

$$H ( k , ℓ ) = [ {h}_{1} ( k , l ) … {h}_{K} ( k , ℓ ) ]$$

denote the multiuser channel matrix,

$$d ( k , ℓ ) = {[ ( {d}_{1} ( k , ℓ ) … {d}_{K} ( k , ℓ ) ]}^{T}$$

denote the vector of transmitted symbols from all the users, and

$$I ( k , ℓ ) = {\sum }_{i = 1}^{{N}_{I}} {I}_{i} ( k , ℓ )$$

denotes the overall interference term. Then, the system model in Equation 1 is equivalent to

$$y \{ k , ℓ ) = H ( k , ℓ ) d ( k , ℓ ) + I ( k , ℓ ) + n ( k , ℓ ) . \qquad ( 2 )$$

In MMSE equalization, the term I(k, l)+n(k, l) is treated as effective noise at the receiver and the equalization is carried using the following Equation:

$$\hat{d} ( k , ℓ ) = {( {H ( k , ℓ )}^{H} H ( k , ℓ ) + {\tilde{σ}}^{2} {I}_{K} )}^{- 1} {H}^{H} ( k , ℓ ) y ( k , ℓ ) , \qquad ( 3 )$$

where \tilde{σ}² is the variance of the effective noise. Let Rz denote the covariance of I(k, l)+n(k, l). Then, the MMSE-IRC equalization is given by:

$$\hat{d} ( k , ℓ ) = {H ( k , l )}^{H} {( H ( k , ℓ ) {H ( k , ℓ )}^{H} + {R}_{z} )}^{- 1} y ( k , ℓ ) . \qquad ( 4 )$$

Due to the Rz term in Equation 4, the interference is effectively suppressed by MMSE-IRC equalizer, leading to superior performance. On the other hand, while MMSE equalization requires computing inverse of K×K matrix, MMSE-IRC requires inverting M×M matrix. Typically, K<M (e.g., K=12 and M=64), and hence the complexity of MMSE-IRC is significantly higher compared with MMSE.

Mmse Vs. Mmse-Irc:

Although MMSE-IRC theoretically achieves superior error performance compared with MMSE, its success in practice requires accurate estimation of the covariance matrix Rz of interference plus noise. The covariance matrix is estimated in practical systems using the DMRS symbols, and hence the accuracy of estimation is limited by the number of available DMRS symbols. Embodiments herein estimate Rz on a per RB basis in a given slot and use the same covariance matrix for equalization in all the REs of the RB in that slot. Embodiments herein present the performance comparison between MMSE and MMSE-IRC under the realistic simulation setting shown in Table 1, and draw some important insights.

TABLE 1

| Parameter | Value |
|---|---|
| Users | 12 |
| BS antennas | 64 |
| Sub-carrier spacing | 15 kHz |
| Resource Blocks | 4 |
| FFT size | 512 |
| Modulation | 16-QAM |
| Coding | Uncoded system |
| Channel model | TDL-C, TDL-D |
| Interferers | 2 |
| DIP | Low: [−9 dB, −11 dB], η = 0.2053 |
| | Moderate: [−5 dB, −11 dB], η = 0.4421 |
| | High: [−1.1 dB, −10.21 dB], η = 0.8556 |
| Channel estimation | Ideal |
| DMRS | Type-1, two instances |

Embodiments herein consider two interferers whose interference is modeled following the third generation partnership project (3GPP) reference document, which defines a metric called the dominant interferer proportion (DIP) ratio. DIP of an interferer i is defined as the ratio of the power of interferer i over the total power of all interferers along with the white noise. In Table 1, the DIP values are shown in the dB scale. The interference proportion, denoted by η, is the sum of the DIP values of all interferers after conversion to a linear scale. It gives the ratio of total interference power to interference plus noise power. By definition, η lies between 0 and 1. If η is close to 1, the proportion of interference is much higher than noise, and hence it is an interference dominant regime. On the other hand, if η is close to 0, the proportion of interference is insignificant compared with noise, and hence it is a noise dominant regime. In the simulations, three regimes are considered, corresponding to low, moderate, and high interference proportions whose DIP values are shown in Table 1.

The performance is studied under tapped delay line (TDL) C and D channel models. In TDL-C model, the channel contains 24 taps, all of which are distributed Rayleigh with specified delays and powers. In TDL-D model, the channel contains 13 taps, wherein the first tap follows Rician distribution (with LOS and NLOS paths) and the remaining taps are distributed Rayleigh.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

Regarding bit error rate (BER) performance of MMSE and MMSE-IRC receivers in TDL-C channel under low, moderate, and high interference regimes under low interference, the performance of MMSE is the same as that of MMSE-IRC. In moderate interference, there is a small performance gain by using MMSE-IRC. Finally, in high interference regime, the performance of MMSE-IRC is significantly better than MMSE. These observations can be explained as follows. For interference proportion of 0.2053, the degradation in performance of MMSE is insignificant as this is a noise dominant scenario with less interference. The performance of MMSE-IRC is however limited by the accuracy of the estimated covariance matrix Rz, which is caused by the limited number of available pilots for its estimation (12 pilots in the present setup using two instances of Type-1 pilots in a slot with per RB estimation), as well as the higher noise level. On the other hand, at moderate to high interference proportions, even though the performance of MMSE-IRC is degraded due to inaccurate covariance estimation when compared with using ideal/perfect R_{z}⁸, the MMSE performance is significantly degraded due to higher interference, making MMSE-IRC more favorable in this regime.

In a performance comparison between MMSE and MMSE-IRC in TDL-D channels, the MMSE performs either better than or almost the same as that of MMSE-IRC in low-to-moderate interference regimes. The performance of MMSE-IRC is superior in high interference regime.

### Opportunistic Receiver:

As discussed in the previous section, MMSE is almost as good as MMSE-IRC under low interference regime in TDL-C channels, and under low-to-moderate interference regimes in TDL-D channels. The complexity of MMSE is however much less than MMSE-IRC since MMSE requires inverting a 12×12 matrix, whereas MMSE-IRC requires inverting a 64×64 matrix. Therefore, instead of using MMSE-IRC in all regimes, the BS receiver can opportunistically switch to MMSE under favorable conditions. This will reduce the average complexity compared with MMSE-IRC without compromising in performance.

For realistic simulations, embodiments herein average the performance and complexity over 1000 realizations of randomly generated DIPs, with the DIPs of interferer 1 and 2 distributed uniformly in the range [−1 dB, −16 dB] such that η≤1.

The opportunistic receiver in TDL-C channel under randomized interferer DIPs according to various embodiments of the disclosure, achieves the best performance on an average, which is due to the fact that it selects the best receiver for each realization of DIPs.

In terms of complexity, as shown in Table 2, the opportunistic receiver achieves about 40% reduction in complexity com-pared with MMSE-IRC.

TABLE 2

| MMSE | MMSE-IRC | Opportunistic Switching | % reduction |
|---|---|---|---|
| 21696 | 286891 | 176840 | 40% |

The opportunistic receiver in TDL-D channel under randomized interferer DIPs according to various embodiments of the disclosure, as shown in Table 3, achieves 62% reduction in complexity compared with MMSE-IRC.

TABLE 3

| MMSE | MMSE-IRC | Opportunistic Switching | % reduction |
|---|---|---|---|
| 21696 | 286891 | 108680 | 62% |

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

FIG. 1A illustrates an environment for determining an optimal equalizer for managing interference in a communication network, according to an embodiment of the disclosure.

The environment 100 comprises a Base Station (BS) 101 connected with one or more User Equipment UE 103 (UE 103₁, UE 103₂, . . . UE 103ₙ) in a cell 102. The one or more UEs 103 may connect with the BS 101 during uplink transmission. Both, the BS 101 and the one or more UEs 103 may comprise a plurality of antennas respectively for uplink and downlink transmission. As shown, the BS 101 may include a plurality of antenna (antenna 105₁, antenna 105₂, . . . antenna 105n, collectively referred as plurality of antenna 105). Each of the one or more UEs 103 may include a plurality of antennas 107, respectively for uplink data transmission. Examples of the one or more UEs 103 may include, but not limited to, any device used by a user to communicate and/or access content such as, but not limited to, mobile phones, smartphones, laptops, and the like. The BS 101 may be one of, a distributed base station and a centralized base station.

FIG. 1B illustrates a block of a base station, according to an embodiment of the disclosure.

Referring to FIG. 1B, the BS 101 may include, an input/output (I/O) interface 109, memory 111 and a processor 113. The I/O interface 109 is coupled with the processor 113 through which an input signal or/and an output signal is communicated. For example, the BS 101 may receive DMRS signals, using the I/O interface 109.

Returning to FIG. 1A, during data transmission, two or more transmitters (UE 103₁, 103₂, . . . 103_{N}) may initiate uplink transmission through respective antennas 107 which may sometime lead to improper frequency coordination leading to interference. In such situation, the BS 101 may manage such interferences. In an embodiment, the interference comprises at least one of, a co-channel interference and Inter-Layer Interference (ILI). The BS 101 may perform adaptive switching between a plurality of equalizers. The plurality of equalizers may include at least one of, a Minimum Mean Squared Error (MMSE) equalizer, MMSE with Interference Rejection Combiner (MMSE-IRC) equalizer, and a MMSE with Successive Interference Cancellation (MMSE-SIC) equalizer. In one implementation, the BS 101 may determine an optimal equalizer for managing the interference based on a trained model using machine learning technique. In another implementation, the BS 101 may determine the optimal equalizer using threshold based adaptive switching.

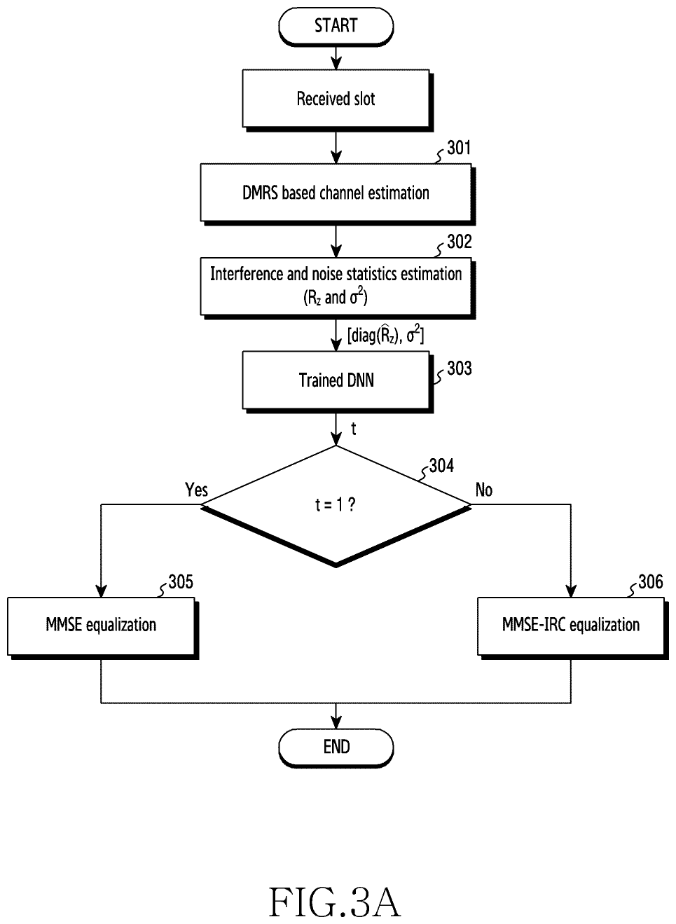

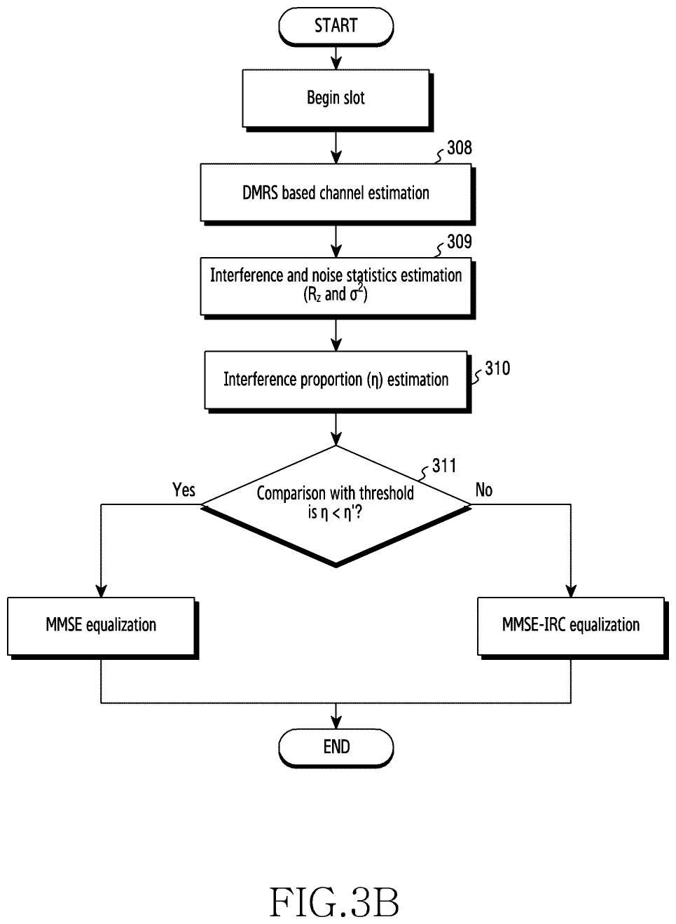

FIGS. 3A and 3B show flowcharts for determining an optimal equalizer for managing the interference based on a trained model using machine learning technique according to various embodiments of the disclosure.

Referring to FIG. 3A, initially at operation 301, during data transmission, the BS 101 may estimate channel coefficients of each slot of a plurality of slots based on received Demodulation Reference Signal (DM-RS) symbols. In an embodiment estimating of the channel coefficients may be performed as per any known techniques in the art. The BS 101 at operation 302 determines a covariance of interference-and-noise (R_{z}) matrix for at least one Resource Block (RB) of a plurality of RBs of each slot based on the channel coefficients. Typically, R_{z} is estimated on a per-B basis for a given slot as follows:

Let_{d} be the number of DMRS REs per RB in a slot,

Let ( [symbol] _{d}, [symbol] _{d}) be the set of RE positions in a slot where DMRS is transmitted;

Let p(k, [symbol] ) be the pilot transmitted in RE (k, [symbol] )∈( [symbol] _{d}, [symbol] _{d});

Then, z(k, [symbol] )=y(k, [symbol] )−H(k, [symbol] )p(k, [symbol] ) is the estimate of interference-plus-noise vector;

Further, the BS 101 may determine a noise variance (σ²) based on noise measurements performed for one or more sub-carriers without the interference.

Generally, one slot is constituted by 14 OFDM symbol while one RB is constituted by 12 consecutive sub-carriers. That is, the slot is across time and the RB is across frequency. Typically, co-channel interference arises from cell edge users. These users may transmit in only a subset of carriers compared with what may be available with the BS 101 to serve its users. The remaining sub-carriers may be interference free. To determine interference free sub-carriers, the BS 101 may observe noise power on each sub-carrier and identify interference free subcarriers as those with least noise power.

Further, at operations 303, 304, 305, and 306, the BS 101 may retrieve diagonal elements of the R_{z} matrix and σ² of the at least one RB. The retrieved diagonal elements of the R_{z} matrix and σ² of the at least one RB are inputted to a machine learning model for determining an optimal equalizer from the plurality of equalizers for managing the interference. The machine learning model may be pretrained by generating input features comprising a plurality of training diagonal elements of R_{z} and σ² of each RB. The training diagonal elements are obtained based on training channel coefficients of each slot based on training dataset of DMRS symbols. The BS 101 may perform equalization on each slot using each of the plurality of equalizers, on the training dataset. Further, decoded bits for each of the equalizers are obtained by performing a predefined decoding technique. In an embodiment, the predefined decoding technique may be low-density parity check code (LDPC). The BS 101 determines numbers of error bits for each slot generated by each of the plurality of equalizers during equalization based on the respective decoded bits. Then, the BS 101 determines output labels for the machine learning model for each slot based on a comparison of the number of error bits corresponding to each of the plurality of equalizers with respect to each other. In an embodiment, the training may be performed such that neural network architecture may comprises M+1 input layers and one or more output layers, wherein the “M” indicates antennas at the BS. The BS 101 may train the machine learning model based on a correlation between interference proportion and operating Signal to Interference Noise Ratio (SINR) associated with a plurality of training diagonal elements.

In another implementation, as shown in FIG. 3B, the BS 101 may determine the optimal equalizer using threshold based adaptive switching. Herein, as shown at operation 308, the BS 101 may estimate the channel coefficients of each slot of a plurality of slots with respect to time based on received Demodulation Reference Signal (DM-RS) symbols. At operation 309, a covariance of interference-and-noise (R_{z}) matrix is determined for at least one RB of the plurality of RBs of each slot based on the channel coefficients. Further, a noise variance (σ²) is determined based on noise measurements performed on one or more sub-carriers without the interference. Then, at operation 310, the BS 101 may estimate an interference proportion for the at least one RB based on the covariance of interference-and-noise (R_{z}) matrix and the noise variance (σ²). Particularly, the BS 101 estimates the interference proportion by identifying diagonal elements from the covariance of interference-and-noise (R_{z}) matrix. Herein, the diagonal elements indicate interference-plus-noise power across each receiver antennas. An interference-plus-noise power is estimated based on an average of the diagonal elements. Then, an interference power is estimated based on a function of the interference-plus-noise power and the noise variance (σ²). Thereafter, the interference proportion is estimated by the BS 101 based on a ratio of the estimated interference power and the interference-plus-noise power.

At operation 311, the BS 101 may determine the optimal equalizer from the plurality of equalizers based on a comparison of the interference proportion with a predetermined interference threshold for the at least one RB. In an embodiment, the predetermined interference threshold is determined and configurable based on Block Error Rate (BLER) performance measurements and predefined configurations of BS 101.

The BS 101 may one of a distributed base station and a centralized base station. An embodiment of a distributed BS is explained in FIG. 1C.

FIG. 1C illustrates an embodiment of a base station in distributed environment for determining an optimal equalizer for managing interference in a wireless communication system, according to an embodiment of the disclosure.

The BS 101 may use distributed architecture (for example, centralized radio access network (C-RAN), virtualized radio access network (vRAN), and O-RAN) for additional flexibility, wherein the operations of the BS 101 may be distributed between a Remote Radio Head (RRH) 115 and a Base Band Unit (BBU) 117. In the distributed BS architecture, the RRH 115 and BBU 117 are connected via a fronthaul link as shown. While different RRHs are located in their respective cell sites, multiple BBUs are located in a single physical location. This reduces the maintenance cost since different cells can be serviced from same physical location by a field maintenance engineer. The RRH 115 performs lower-PHY operations (such as, sampling, analog-to-digital converter (ADC)) and a part of Rx signal processing (depending on functional split). While the BBU 117 performs computationally intensive signal processing.

In the distributed BS, the disclosure identifies whether the optimal equalizer selection is made at RRH 115 or the BBU 117. In one embodiment, the decision on the optimal equalizer in a given RB may be taken at the RRH 115 in every slot. In such case, computationally intensive inverse calculations and channel estimation may be performed at BBU 117.

In such case, initially, SRS from a user equipment may be received by the BBU 117. Based on the received SRS, the BBU 117 may estimate channel estimations and transmits the same to the RRH 115. Further, once a user associated with the UE transmits data on PUSCH channel, the RRH 115 may determine interference statistics using DMRS and channel shared by the BBU 117. Then, the RRH 115 may perform determine the optimal equalizer from the plurality of equalizers based on the interference and noise statistics using the trained machine learning model implemented at the RRH 115. For instance, for RBs where MMSE is selected as the optimal equalizer, the RRH 115 may computes H^{H}y and transmits to the BBU 117 (Dimension=number of transmitting layers). The BBU 117 may then perform the computation (H^{H}H+σ²I)⁻¹ and multiplies it to H^{H}y to obtain MMSE estimate. For RBs where MMSE-IRC is selected, the RRH 115 may transmit “y” to the BBU 117 without combining (Dimension=#Rx antennas at RRH). In such case, the entire MMSE-IRC computation H^{H}(HH^{H}+\hat{R}_{z})⁻¹y is performed at the BBU 117.

In another implementation, the decision on the optimal equalizer in a given RB may be performed at the BBU 117 during the SRS slots, and the selected equalizer may be used till the next SRS arrives. All computations (such as, interference estimation, adaptive switching, channel estimation, equalization, and the like) are performed at the BBU 117, and hence RRH implementation is highly simplified.

In this implementation, initially, the SRS transmitted from the users may be received by the BBU 117. Based on the received SRS, the BBU 117 may estimate channel and interference statistics. Further, the BBU 117 may perform AI-based switching and determine the optimal equalizer for each RB. In such case, the BBU 117 transmits the information on the optimal equalizer for each RB with the RRH 115. In an example, in each RB for which MMSE is optimal, the RRH 115 may compute the H^{H}y and transmits to the BBU 118 (Dimension=#Tx layers). Then, the BBU 117 performs the computation (H^{H}H+ [symbol] ²I)⁻¹ and associates it to H^{H}y to obtain MMSE estimate. While, in RBs where MMSE-IRC is optimal, the RRH 115 may transmit the “y” to the BBU 117 without combining (Dimension=#Rx antennas at RRH). Thus, the entire MMSE-IRC computation H^{H} (HH^{H}+\hat{R}_{z})⁻¹y is performed at the BBU 117.

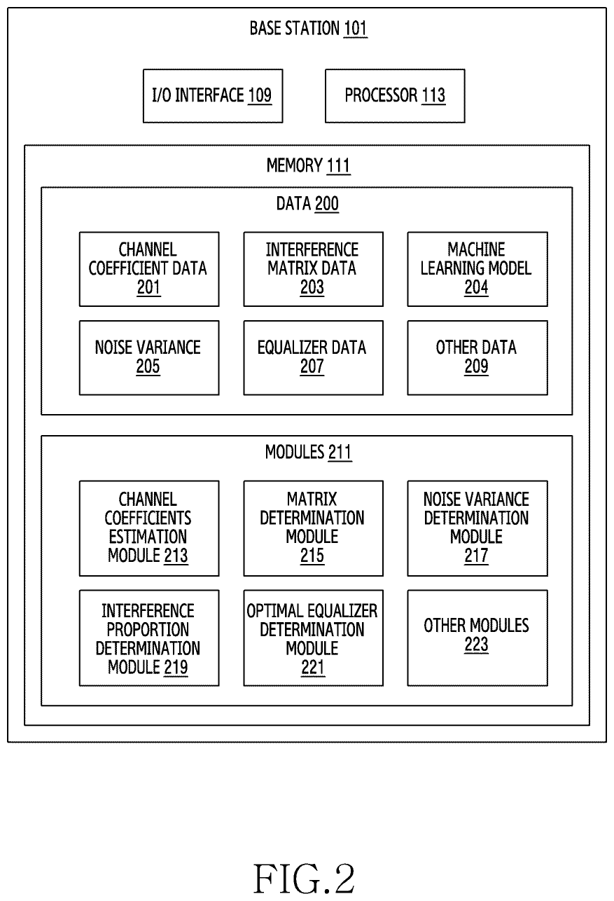

FIG. 2 illustrates a detailed diagram of a base station for determining an optimal equalizer for managing interference in a wireless communication system, according to an embodiment of the disclosure.

The BE 101 may include the Central Processing Units 113 (also referred as “CPUs” or “a processor 113”), the Input/Output (I/O) interface 109, and the memory 111. In some embodiments, the memory 111 may be communicatively coupled to the processor 113. The memory 111 stores instructions executable by the processor 113. The processor 113 may comprise at least one data processor for executing program components for executing user or system-generated requests. The memory 111 may be communicatively coupled to the processor 113. The memory 111 stores instructions, executable by the processor 113, which, on execution, may cause the processor 113 to determine an optimal equalizer for managing interference in a wireless communication system. In an embodiment, the memory 111 may include one or more modules 211 and data 200. The one or more modules 211 may be configured to perform the steps of the disclosure using the data 200, to determine an optimal equalizer for managing interference in a wireless communication system. In an embodiment, each of the one or more modules 211 may be a hardware unit which may be outside the memory 111 and coupled with the BS 101. As used herein, the term modules 211 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 211 when configured with the described functionality defined in the disclosure will result in a novel hardware.

In one implementation, the modules 211 may include, for example, a channel coefficients estimation module 213, a matrix determination module 215, a noise variation determination module 217, an interference proportion estimating module 219, an optimal equalizer determination module 221, and other modules 223. It will be appreciated that such aforementioned modules 211 may be represented as a single module or a combination of different modules. In one implementation, the data 200 may include, for example, channel coefficient data 201, interference matrix data 203, machine learning(or deep learning) model 204, noise variance 205, equalizer data 207, and other data 209.

In an embodiment, the channel coefficients estimation module 213 may estimate the channel coefficients of each slot of the plurality of slots with respect to time based on received Demodulation Reference Signal (DM-RS) symbol. In an embodiment, the channel coefficients estimation module 213 may use the DMRS symbol information and estimate the channel coefficients using any known estimation techniques. The channel coefficients estimated based on the DMRS symbol may be stored as the channel coefficient data 201.

In an embodiment, the matrix determination module 215 may be configured to receive the channel coefficients from the channel coefficients estimation module 213 and determine the covariance of interference-and-noise (R_{z}) matrix for at least one Resource Block (RB) of the plurality of RBs of each slot based on the channel coefficients. The covariance of interference-and-noise (R_{z}) matrix may be stored as the interference matrix data 203. The covariance of interference-and-noise (R_{z}) matrix is represented by Equation 5 below. Typically, R_{z} is estimated on a per-B basis for a given slot as follows:

Let N_{d} be the number of DMRS REs per RB in a slot,

Let ( [symbol] _{d}, [symbol] _{d}) be the set of RE positions in a slot where DMRS is transmitted;

Let p(k, [symbol] ) be the pilot transmitted in RE(k, [symbol] )∈( [symbol] _{d}, [symbol] _{d});

Then, z(k, [symbol] )=y(k, [symbol] )−H(k, [symbol] )p(k, [symbol] ) is the estimate of interference-plus-noise vector;

The covariance is estimated as:

$${\hat{R}}_{z} = \frac{1}{{N}_{d}} {\sum }_{( k , ℓ ) ∈ ( {𝒦}_{d} , {ℒ}_{d} )} z ( k , ℓ ) {z ( k , ℓ )}^{H} \qquad Equation 5$$

In an embodiment, the noise variation determination module 217 may determine the noise variance (σ²) based on noise measurements performed for one or more sub-carriers without the interference. Generally, one slot is constituted by 14 OFDM symbol while one RB is constituted by 12 consecutive sub-carriers. That is, the slot is across time and the RB is across frequency. The determined noise variance may be stored as the noise variance 205. Typically, co-channel interference arises from cell edge users. These users may transmit in only a subset of carriers compared with what may be available with the BS 101 to serve its users. The remaining sub-carriers may be interference free. To determine interference free sub-carriers, the noise variation determination module 217 may observe noise power on each sub-carrier and identify interference free subcarriers as those with least noise power. The noise variance (σ²) may be determined using Equation 6 as defined below.

$${\tilde{σ}}^{2} = \frac{1}{M} {z ( k , ℓ )}^{H} z ( k , ℓ ) \qquad Equation 6$$

In an embodiment, the interference proportion estimating module 219 may estimate the interference proportion for the at least one RB based on the covariance of interference-and-noise (R_{z}) matrix and the noise variance. Particularly, the interference proportion estimating module 219 may estimate the interference proportion for the at least one RB by identifying diagonal elements from the covariance of interference-and-noise (R_{z}) matrix. Herein, the diagonal elements indicate interference-plus-noise power across each receiver antennas. The interference proportion estimating module 219 may then estimate an interference-plus-noise power based on an average of the diagonal elements. Then, an interference power is estimated based on a function of the interference-plus-noise power and the noise variance (σ²). Thereafter, the interference proportion estimating module 219 may estimate the interference proportion based on a ratio of the estimated interference power and the interference-plus-noise power.

In an embodiment, the optimal equalizer determination module 221 may be configured to determine an optimal equalizer from the plurality of equalizers for managing the interference, based on diagonal elements of the R_{z} matrix and σ² of the at least one RB. The determined optimal equalizer may be stored as the equalizer data 207. In one implementation, the optimal equalizer determination module 221 may determine the optimal equalizer using the machine learning(or deep learning) model 204 based on the diagonal elements of the R_{z} matrix and σ² of the at least one RB.

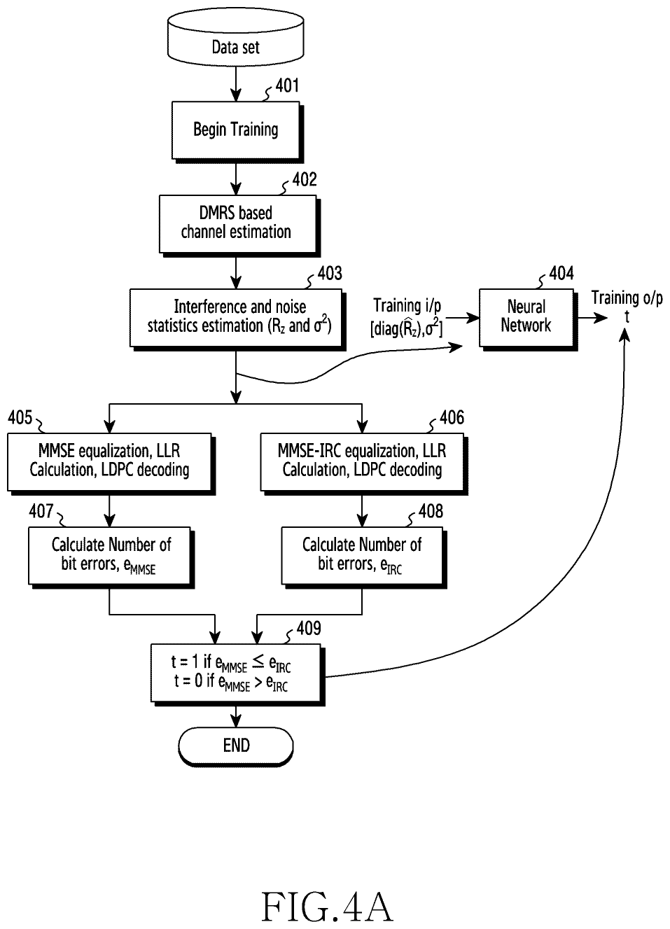

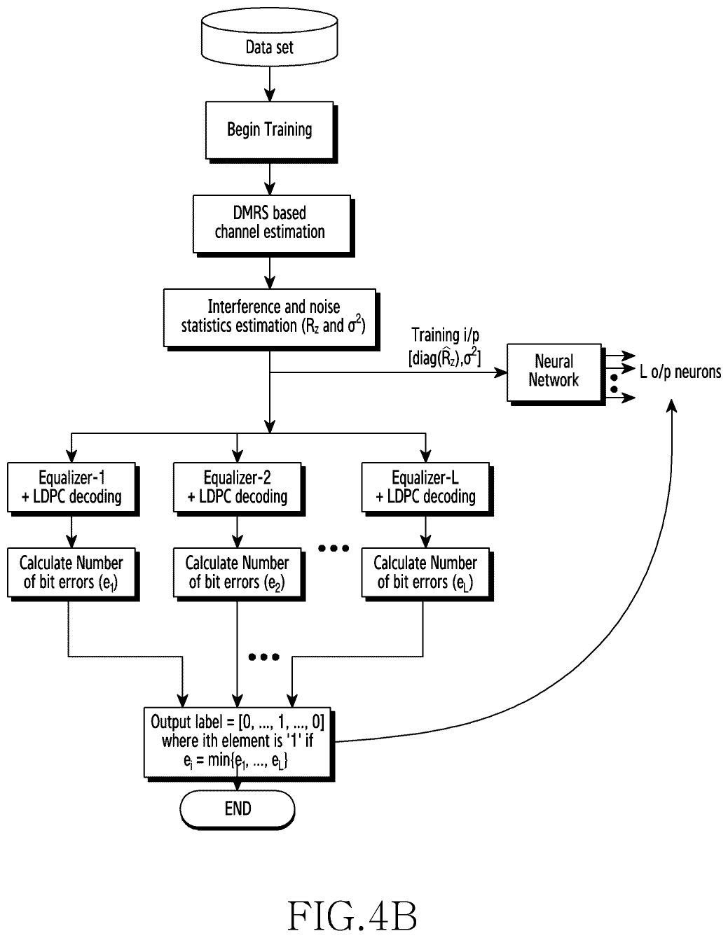

FIGS. 4A and 4B show flow diagrams of training a machine learning model for determining an optimal equalizer according to various embodiments of the disclosure.

Throughout various embodiments, The machine learning model may be referred to an artificial intelligence (AI) model, or the like. The machine learning model may be trained based on training dataset comprising data points each corresponding to an OFDM slot and is composed of, transmission bits, received baseband signal vectors, DMRS symbols, and noise variance in respective slot. As shown in operations 401 and 402, channel estimation is performed for each slot based on received DMRS symbols stored in a dataset. At operation 403, by using the estimated channels from operation 402, the covariance of interference-plus-noise R_{z} is estimated for each RB of all the slots in the dataset. Next, at operation 404, vectors [diag(\hat{R}_{z})σ²] are formed for each RB of all slots and stored as input features to be used for training. Then, at operations 405 and 406, outputs/labels for the model training are the decisions on optimal equalizer between the MMSE and MMSE-IRC in each RB (or RB-group). To obtain these decision labels, both MMSE and MMSE-IRC are performed on each slot in the training dataset, followed by LDPC decoding to recover the data bits.

At operations 407 and 408, the decoded bits from MMSE and MMSE-IRC equalizers are compared with transmitted bits, and the number of bit errors produced by MMSE (e_{MMSE}) and MMSE-IRC (e_{IRC}) are calculated for all slots. Lastly, at operation 409, if the number of errors produced by MMSE is less than MMSE-IRC (e_{MMSE}≤e_{IRC}), then MMSE is selected as the optimal equalizer and the decision label is set as t=1. On the other hand, if e_{IRC}<e_{MMSE}, then MMSE-IRC is selected as the optimal equalizer, and the decision label is set as t=0. The decision labels for all slots are stored to be used as training labels for the machine learning model.

FIG. 4A show the flow diagram of training the machine learning model with respect to two equalizers according to an embodiment of the disclosure.

However, the disclosure may also include training the machine learning model with respect to multiple equalizers as shown in FIG. 4B. Training the machine learning model 204 with multiple equalizers include same operations as discussed in FIG. 4A, except that of generation of output labels for the training. This is highlighted as bold in the FIG. 4B. Explanations for other operations are omitted to avoid repetition. In this case particularly wherein optimal equalizer is to be determined between a plurality of equalizers (equalizer 1, . . . equalizer L), the machine learning model is required to include L output neurons and one-hot representation for output labels. That is, for a given RB of the dataset, if Equalizer-i produces the least number of errors, then the output label is a one-hot vector of length L that contains ‘1’ in ith position and ‘0’ in the remaining positions. The machine learning model is then trained with [diag(\hat{R}_{z}), σ²] as input and one-hot label as output.

While performing the training, the optimal equalizer determination module 221 may select a neural network architecture such that it comprises M+1 input layers and one output layer. In an embodiment, the number of hidden layers and the neurons in each hidden layer can be chosen flexibly based on experimentation to balance performance-complexity trade-off. In an embodiment, a deep neural network, and the machine learning model 204 may be trained by feeding the vectors [diag(\hat{R}_{z}) σ²] as input and the optimal equalizer label t as output (as discussed above). In an embodiment, sigmoid/softmax activation layer may be used for output layer. In an embodiment, the training of the machine learning model 204 may be performed offline before implementing the system in real-time.

In another implementation, the optimal equalizer determination module 221 may determine the optimal equalizer by receiving the interference proportion from the interference proportion estimating module 219 and comparing it with a predetermined interference threshold for the at least one RB. For instance, if the estimated interference proportion is less than the predetermined threshold, the optimal equalizer determination module 221 may determine to use the MMSE, so that complexity is reduced without loss in performance. While, if the estimated interference proportion is more than the pre-determined threshold, the optimal equalizer determination module 221 may use the MMSE-IRC so that the co-channel interference is effectively mitigated.

The other data 209 may store data, including temporary data and temporary files, generated by the one or more modules 211 for performing the various functions of the BS 101. The one or more modules 211 may also include the other modules 223 to perform various miscellaneous functionalities of the BS 101. The other data 209 may be stored in the memory 111. It will be appreciated that the one or more modules 223 may be represented as a single module or a combination of different modules.

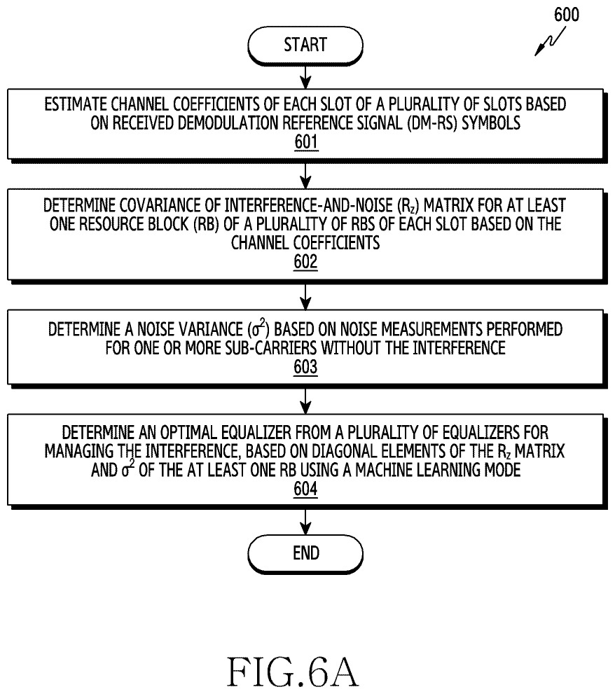

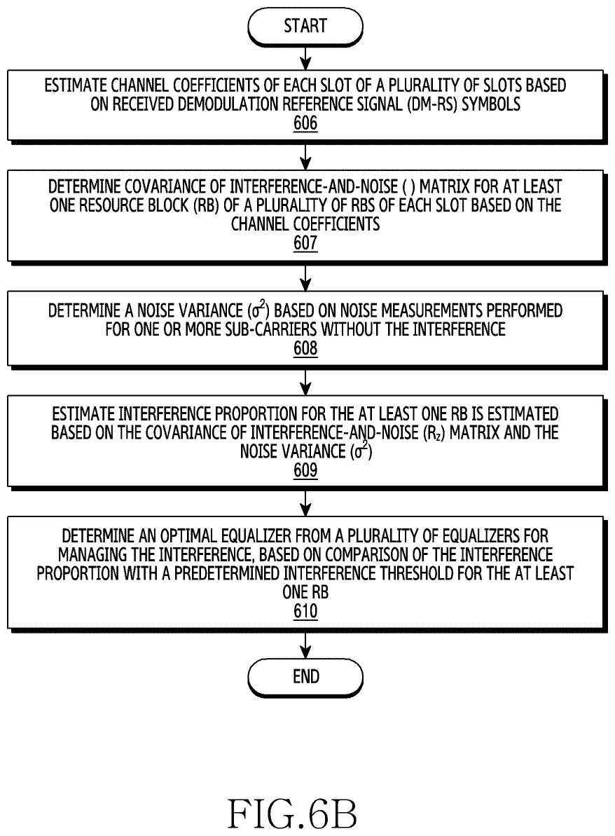

FIGS. 6A and 6B show flowcharts illustrating method operations for determining an optimal equalizer for managing interference in a wireless communication system, according to various embodiments of the disclosure.

Referring to FIG. 6A, the method 600 may comprise one or more operations. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof. FIG. 6A explicitly shows a flowchart illustrating method operations for determining an optimal equalizer for managing interference using a machine learning model in a wireless communication system.

At operation 601, channel coefficients of each slot of the plurality of slots is estimated based on the received Demodulation Reference Signal (DM-RS) symbols.

At operation 602, a covariance of interference-and-noise (R_{z}) matrix is determined for at least one Resource Block (RB) of a plurality of RBs of each slot based on the channel coefficients.

At operation 603, a noise variance (σ²) is determined based on noise measurements performed for one or more sub-carriers without the interference.

At operation 604, an optimal equalizer from a plurality of equalizers for managing the interference, based on diagonal elements of the R_{z} matrix and σ² of the at least one RB using a machine learning model. Herein, the plurality of equalizers comprises at least one of, a Minimum Mean Squared Error (MMSE) equalizer, MMSE with Interference Rejection Combiner (MMSE-IRC) equalizer, and a MMSE with Successive Interference Cancellation (MMSE-SIC) equalizer. The machine learning model may be pretrained by generating input features comprising a plurality of training diagonal elements of R_{z} and σ² of each RB. The training diagonal elements are obtained based on training channel coefficients of each slot based on training dataset of DMRS symbols. The equalization is performed on each slot using each of the plurality of equalizers, on the training dataset. Further, decoded bits for each of the equalizers are obtained by performing the predefined decoding technique. Then, a number of error bits are determined for each slot generated by each of the plurality of equalizers during equalization based on the respective decoded bits. Then, output labels are determined for the machine learning model for each slot based on a comparison of the number of error bits corresponding to each of the plurality of equalizers with respect to each other. In an embodiment, the machine learning model may be trained based on a correlation between interference proportion and operating Signal to Interference Noise Ratio (SINR) associated with a plurality of training diagonal elements.

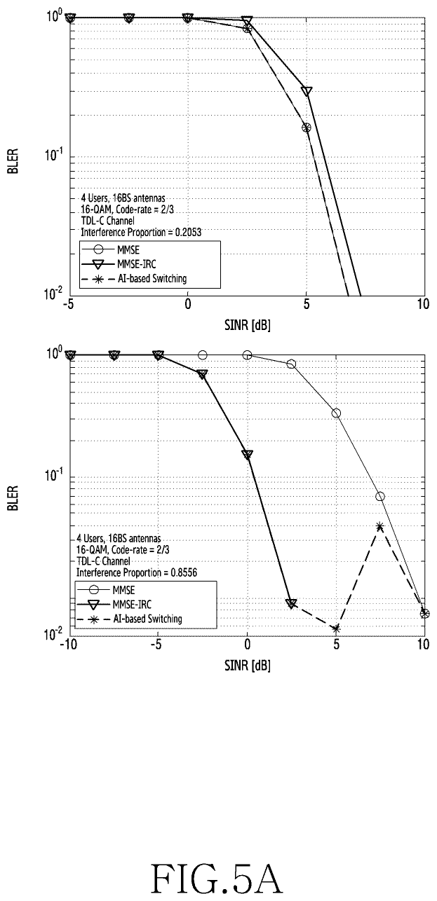

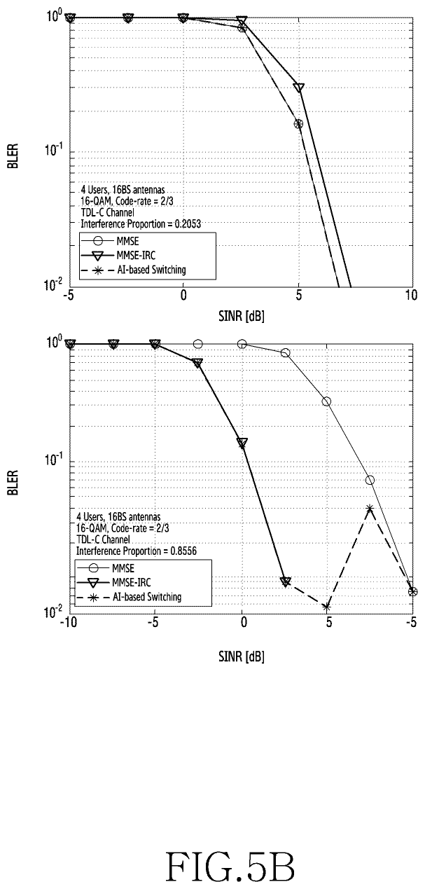

FIGS. 5A and 5B show graphs for showing accuracy of adaptive switching of equalizers according to various embodiments of the disclosure.

For instance, numerical evaluations are performed for two system configurations, 4 Tx layers, 16 Rx antennas as shown in FIG. 5A and 12 Tx layers, 64 Rx antennas as shown in FIG. 5B. Consider, the dataset for both the above configurations consist of 10000 points, such that each data point is formed by (Tx bits, received vectors, DMRS symbols, noise variance). The datasets are processed for generating input features and output labels for model training.

For the machine learning architecture for 4Tx, 16Rx system, consider the inputs as →16→ReLU→8 ReLU→4 ReLU→1→Sigmoid.

Consider, three hidden layers are present with 16, 8, and 4 neurons, respectively.

Output layer uses sigmoid activation, while rest of the layers use ReLU activation.

The training is carried out and the trained model is used for determining the optimal equalizer. In an example, the network may perform around 465 floating point operations (FLOPs) for selecting the optimal equalizer. Since machine learning switching is performed once per RB, this amounts to 465 FLOPs per RB to decide the optimal equalizer. Therefore, the complexity overhead induced by the machine learning model per RE is

$$\frac{465}{12 \times 12} \approx 4 FLOPs ,$$

which is insignificant compared with the complexity of performing MMSE (747 FLOPs) and MMSE-IRC (5675 FLOPs) in each RE.

For the machine learning architecture of 12Tx, 16Rx system configuration, consider inputs as, i/p→32→ReLU→16 ReLU→4 ReLU→1→Sigmoid. In this case, the machine learning switching with the above network requires around 2713 FLOPs per RB and hence around twenty FLOPs per RE. This is insignificant compared with the complexity of MMSE (21696 FLOPs) and MMSE-IRC (286891 FLOPs) in each RE.

In an embodiment, the machine learning based optimal equalizer determination may be validated via 5G link level simulations. The numerical results in terms of the complexity reduction and switching accuracy (i.e., the percentage of times AI-based switching selects the optimizer equalizer) are shown in below Table 4 under TDL-C and D channels. In an example, 15 kHz sub-carrier spacing, 16-QAM modulation and rate-2/3 LDPC code are used. The interference proportion is randomly distributed between 0 and 1 in each slot, and the simulations are carried out for 10,000 slots.

TABLE 4

| | | Complexity reduction | |
|---|---|---|---|
| System | Channel | w.r.t MMSE-IRC | Switching Accuracy |
| 4Tx, 16Rx | TDL-C | 47% | 90% |
| 4Tx, 16Rx | TDL-D | 62.67% | 91.5% |
| 12Tx, 64Rx | TDL-C | 52% | 92% |
| 12Tx, 64Rx | TDL-D | 66% | 91.3% |

The Table 4 shows that, the machine learning based switching achieves significant reduction in complexity compared with MMSE-IRC. For example, for 12Tx and 64Rx system, complexity is reduced by up to 66% while also achieving reliable equalization.

FIG. 6B shows a flowchart illustrating method operations for determining an optimal equalizer for managing interference using a threshold based technique in a wireless communication system according to an embodiment of the disclosure.

As shown, at operation 606 is equivalent to operations 601, 607 is similar to operations 602 and 608 is same as operation 603. Further, at operation 609, an interference proportion for the at least one RB is estimated based on the covariance of interference-and-noise (R_{z}) matrix and the noise variance (σ²). At operation 610, an optimal equalizer from a plurality of equalizers is determined based on a comparison of the interference proportion with a predetermined interference threshold for the at least one RB. For instance, if the estimated interference proportion is less than the predetermined threshold, the MMSE may be determined as the optimal equalizer, so that complexity is reduced without loss in performance. While, if the estimated interference proportion is more than the pre-determined threshold, the MMSE-IRC may be determined as the optimal equalizer so that the co-channel interference is effectively mitigated.

### Computer System

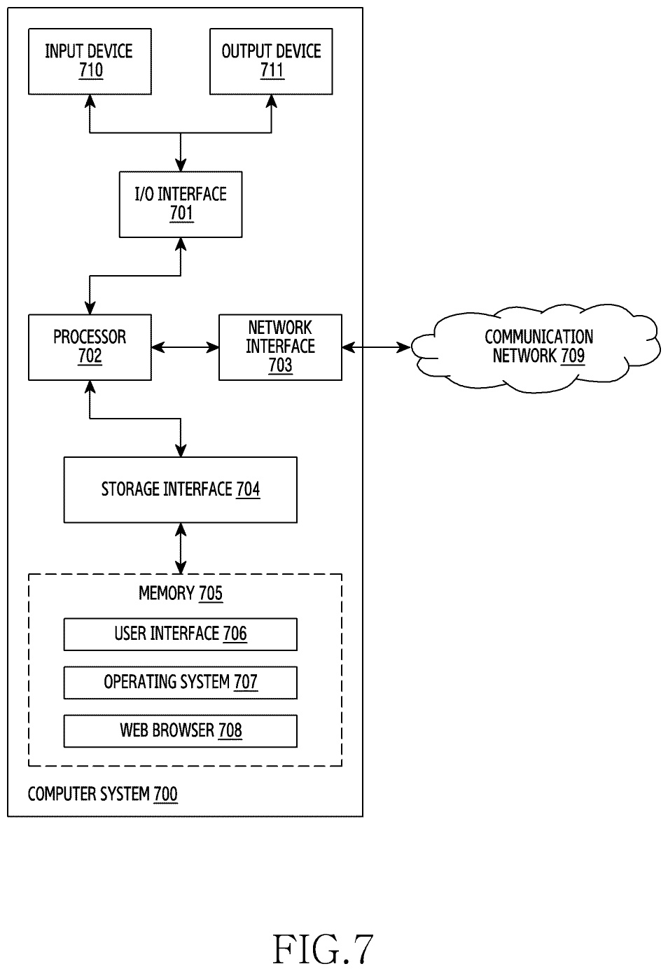

FIG. 7 illustrates a block diagram of a computer system 700 according to an embodiment of the disclosure.

In an embodiment, the computer system 700 may be the BS 101. Thus, the computer system 700 may be used to determine an optimal equalizer for managing interference in a wireless communication system. The computer system 700 may transmit the one or more requests to the network (for instance, a base station in the network), over a communication network 709. The computer system 700 may comprise a Central Processing Unit 702 (also referred as “CPU” or “processor”). The processor 702 may comprise at least one data processor. The processor 702 may include specialized processing units such as integrated system (bus) controllers, memory management control units, floating point units, graphics processing units, digital signal processing units, etc.

The processor 702 may be disposed in communication with one or more input/output (I/O) devices (not shown) via I/O interface 701. The I/O interface 701 may employ communication protocols/methods such as, without limitation, audio, analog, digital, monoaural, RCA, stereo, Institute of Electrical and Electronics Engineers (IEEE)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), worldwide interoperability for microwave access (WiMax), or the like), etc.

Using the I/O interface 701, the computer system 700 may communicate with one or more I/O devices. For example, the input device 710 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 711 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 702 may be disposed in communication with the communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 709 may include, without limitation, a direct interconnection, local area network (LAN), wide area network (WAN), wireless network (e.g., using Wireless Application Protocol), the Internet, etc. The network interface 703 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 709 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 702 may be disposed in communication with memory 705 (e.g., RAM, ROM, etc. not shown in FIG. 7) via a storage interface 704. The storage interface 704 may connect to the memory 705 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface 706, an operating system 707, web browser 708 etc. In some embodiments, computer system 700 may store user/application data, such as, the data, variables, records, etc., as described in this disclosure. Such databases may be implemented as fault-tolerant, relational, scalable, secure databases such as Oracle® or Sybase®.

The operating system 707 may facilitate resource management and operation of the computer system 700. Examples of operating systems include, without limitation, APPLE MACINTOSH® OS X, UNIX®, UNIX-like system distributions (E.G., BERKELEY SOFTWARE DISTRIBUTION™ (BSD), FREEBSD™ NETBSD™, OPENBSD™, etc.), LINUX DISTRIBUTIONS™ (E.G., RED HAT™ UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In some embodiments, the computer system 700 may implement the web browser 708 stored program component. The web browser 708 may be a hypertext viewing application, for example MICROSOFT® INTERNET EXPLORER™ GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX™, DHTML™, ADOBE® FLASH™, JAVASCRIPT™, JAVA™, Application Programming Interfaces (APIs), etc. In some embodiments, the computer system 700 may implement a mail server (not shown in Figure) stored program component. The mail server may be an Internet mail server such as Microsoft Exchange, or the like. The mail server may utilize facilities such as ASP™ ACTIVEX™, ANSI™ C++/C#, MICROSOFT®, NET™, CGI SCRIPTS™, JAVA™ JAVASCRIPT™, PERL™, PHP™ PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 700 may implement a mail client stored program component. The mail client (not shown in Figure) may be a mail viewing application, such as APPLE® MAIL™, MICROSOFT® ENTOURAGE™ MICROSOFT® OUTLOOK™, MOZILLA® THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

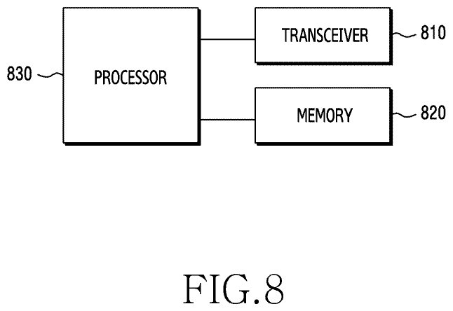

FIG. 8 illustrates a structure of a base station according to an embodiment of the disclosure.

Referring to FIG. 8, the base station according to an embodiment may include a transceiver 810, memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. The base station of FIG. 8 may correspond to the base station of FIG. 1B.

The transceiver 810 collectively refers to a base station receiver and a base station transmitter, and may transmit/receive a signal to/from a terminal (UE) or a network entity. The signal transmitted or received to or from the terminal or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

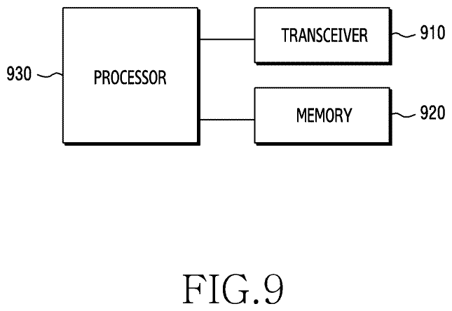

FIG. 9 illustrates a structure of a user equipment according to an embodiment of the disclosure.

Referring to FIG. 9, the UE according to an embodiment may include a transceiver 910, memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

The disclosure provides a solution to an important bottleneck in the 5G and beyond systems. Specifically, the disclosure provides an AI-based methods for significantly reducing the equalization complexity in 5G and beyond BSs, while also improving the equalization performance in the presence of co-channel interference. An embodiment of the disclosure saves significant computational resources and power. The disclosure is also extended to the O-RAN architecture. An embodiment of the disclosure enables to provide reliable communication to its users even under dense networks with co-channel interference.

Existing techniques reduces the complexity of MMSE-IRC and try to approximate the inverse calculation via series expansions and iterations. These approaches either require non-trivial changes in the existing receivers or suffer from performance degradation due to poor approximations. The disclosure takes a completely different approach wherein the BS switches adaptively between multiple equalizers, and hence no changes in existing receiver are necessary. Also, since no approximations are involved, the disclosure do not suffer from performance loss. In fact, the disclosure provides better performance than MMSE-IRC under certain regimes.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 6A and 6B show certain events occurring in a certain order. In alternative embodiments, certain operations may be performed in a different order, modified, or removed. Moreover, operations may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been own and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station (BS) in a wireless communication system, the method comprising:
estimating channel coefficients of each slot of a plurality of slots based on received demodulation reference signal (DM-RS) symbols;
determining a covariance of interference-and-noise (R_{z}) matrix for at least one resource block (RB) of a plurality of RBs of each slot based on the channel coefficients;
determining a noise variance (σ²) based on noise measurements performed for one or more sub-carriers without the interference; and
determining an optimal equalizer from a plurality of equalizers, based on diagonal elements of the R_{z} matrix and σ² of the at least one RB using an artificial intelligence (AI) model.

2. The method of claim 1, wherein the plurality of equalizers comprises at least one of a minimum mean squared error (MMSE) equalizer, MMSE with interference rejection combiner (MMSE-IRC) equalizer, or an MMSE with successive interference cancellation (MMSE-SIC) equalizer.

3. The method of claim 1, wherein the interference comprises at least one of a co-channel interference, or inter-layer interference (ILI).

4. The method of claim 1, wherein the AI model is trained by:
generating input features comprising a plurality of training diagonal elements of R_{z} and σ\hat{ }2 of each RB, wherein the training diagonal elements are obtained based on training channel coefficients of each slot based on training dataset of DM-RS symbols;
performing equalization on each slot using each of the plurality of equalizers, on the training dataset;
obtaining decoded bits for each of the equalizers by performing a predefined decoding technique;
determining numbers of error bits for each slot generated by each of the plurality of equalizers during equalization based on the respective decoded bits; and
determining output labels for the AI model for each slot based on a comparison of the number of error bits corresponding to each of the plurality of equalizers with respect to each other.

5. The method of claim 1, wherein the AI model is trained based on a correlation between interference proportion and operating signal to interference noise ratio (SINR) associated with a plurality of training diagonal elements.

6. The method of claim 1,
wherein the AI model comprises M+1 input layers and one or more output layers, and
wherein “M” indicates antennas at the BS.

7. The method of claim 1, wherein the BS is one of a distributed BS or a centralized BS.

8. A method performed by a base station (BS) in a wireless communication system, the method comprising:
estimating channel coefficients of each slot of a plurality of slots with respect to time based on received demodulation reference signal (DM-RS) symbols;
determining a covariance of interference-and-noise (R_{z}) matrix for at least one resource block (RB) of a plurality of RBs of each slot based on the channel coefficients;
determining a noise variance (σ²) based on noise measurements performed on one or more sub-carriers without the interference;
estimating an interference proportion for the at least one RB based on the covariance of interference-and-noise (R_{z}) matrix and the noise variance (σ²); and
determining an optimal equalizer from a plurality of equalizers based on a comparison of the interference proportion with a predetermined interference threshold for the at least one RB.

9. The method of claim 8, wherein the plurality of equalizers comprises at least one of a minimum mean squared error (MMSE) equalizer, MMSE with interference rejection combiner (MMSE-IRC) equalizer, or an MMSE with successive interference cancellation (MMSE-SIC) equalizer.

10. The method of claim 9, wherein, in case that the estimated interference proportion is less than the predetermined interference threshold, the optimal equalizer is determined to be the MMSE.

11. The method of claim 9, wherein, in case that the estimated interference proportion is more than the predetermined interference threshold, the optimal equalizer is determined to be the MMSE-IRC.

12. The method of claim 8, wherein the predetermined interference threshold is determined based on block error rate (BLER) performance measurements and predefined configurations of BS.

13. The method of claim 8, wherein estimating the interference proportion for the at least one RB based on the covariance of interference-and-noise (R_{z}) matrix and the noise variance (σ²) comprises:
identifying diagonal elements from the covariance of interference-and-noise (R_{z}) matrix, wherein the diagonal elements is indicative of interference-plus-noise power across each receiver antennas;
estimating interference-plus-noise power based on an average of the diagonal elements;
estimating interference power based on a function of the interference-plus-noise power and the noise variance (σ²); and
estimating the interference proportion based on a ratio of the estimated interference power and the estimated interference-plus-noise power.

14. A base station (BS) in a wireless communication system, the BS comprising:
memory storing one or more computer programs; and
one or more processors communicatively coupled to the memory,
wherein the one or more computer programs include computer-executable instructions that, when executed by the one or more processors, cause the BS to:
estimate channel coefficients of each slot of a plurality of slots with respect to time based on received demodulation reference signal (DM-RS) symbols,
determine a covariance of interference-and-noise (R_{z}) matrix for at least one resource block (RB) of a plurality of RBs of each slot based on the channel coefficients,
determine a noise variance (σ²) based on noise measurements performed on one or more free sub-carriers without the interference, and
determine an optimal equalizer from a plurality of equalizers for managing the interference based on diagonal elements of the R_{z} matrix and σ² of the at least one RB using an artificial intelligence (AI) model.

15. The BS of claim 14, wherein the plurality of equalizers comprises at least one of a minimum mean squared error (MMSE) equalizer, MMSE with interference rejection combiner (MMSE-IRC) equalizer, or an MMSE with successive interference cancellation (MMSE-SIC) equalizer.

16. The BS of claim 14, wherein the interference comprises at least one of a co-channel interference or inter-layer interference (ILI).

17. The BS of claim 14, wherein, to train the AI model, the one or more computer programs further include computer-executable instructions that, when executed by the one or more processors, cause the BS to:
generate input features comprising a plurality of training diagonal elements of R_{z} and σ² of each RB, wherein the training diagonal elements are obtained based on training channel coefficients of each slot based on training dataset of DM-RS symbols,
perform equalization on each slot using each of the plurality of equalizers, on the training dataset,
obtain decoded bits for each of the equalizers by performing a predefined decoding technique,
determine numbers of error bits for each slot generated by each of the plurality of equalizers during equalization based on the respective decoded bits, and
determine output labels for the AI model for each slot based on a comparison of the number of error bits of each of the plurality of equalizers.

18. The BS of claim 14, wherein the one or more computer programs further include computer-executable instructions that, when executed by the one or more processors, cause the BS to train the AI model based on a correlation between interference proportion and operating signal to interference noise ratio (SINR) associated with a plurality of training diagonal elements.

19. The BS of claim 14,
wherein the AI model comprises M+1 input layers and one or more output layers, and
wherein “M” indicates antennas at the BS.

20. A base station (BS) in a wireless communication system, the BS comprising:
memory storing one or more computer programs; and
one or more processors communicatively coupled to the memory,
wherein the one or more computer programs include computer-executable instructions that, when executed by the one or more processors, cause the BS to:
estimate channel coefficients of each slot of a plurality of slots with respect to time based on received demodulation reference signal (DM-RS) symbols;
determine a covariance of interference-and-noise (R_{z}) matrix for at least one resource block (RB) of a plurality of RBs of each slot based on the channel coefficients;
determine a noise variance (σ²) based on noise measurements performed on one or more sub-carriers without the interference;
estimate an interference proportion for the at least one RB based on the covariance of interference-and-noise (R_{z}) matrix and the noise variance (σ²); and
determine an optimal equalizer from a plurality of equalizers based on a comparison of the interference proportion with a predetermined interference threshold for the at least one RB.
